(19) United States
(12) Patent Application Publication
(10) Pub. No.: US 2024/0078921 A1
(43) Pub. Date: Mar. 7, 2024

(54) METHOD, SYSTEM AND NON-TRANSITORY COMPUTER-READABLE RECORDING MEDIUM FOR ANSWERING PREDICTION FOR LEARNING PROBLEM

(71) Applicant: VITRUV INC., Seoul (KR)

(72) Inventors: Jaehyeong AHN, Bucheon-si (KR); Tae Hyoung OH, Seoul (KR); Sang Hoon LEE, Seoul (KR); Du Seop JUNG, Seongnam-si (KR); Myunghoon AHN, Seoul (KR)

(73) Assignee: VITRUV INC., Seoul (KR)

(21) Appl. No.: 18/137,089

(22) Filed: Apr. 20, 2023

(30) Foreign Application Priority Data
Apr. 21, 2022 (KR) 10-2022-0049654

(51) Int. Cl. G09B 3/02; G06N 20/00

(52) U.S. Cl. CPC G09B 3/02; G06N 20/00

(57) ABSTRACT

A method for providing a correctness/incorrectness prediction for a learning question is provided. The method includes the steps of: acquiring a set of data including a user variable determined on the basis of concept-specific correctness/incorrectness sequence data of at least one user, and at least one variable related to a question and a concept associated with the user variable; and calculating a probability that a first user corresponding to a specific user variable correctly answers a first question corresponding to a specific concept, with reference to the data set.

### CROSS-REFERENCE TO RELATED APPLICATION

This application claims priority to Korean Patent Application No. 10-2022-0049654 filed on Apr. 21, 2022, the entire contents of which are herein incorporated by reference.

### FIELD OF THE INVENTION

The present invention relates to a method, system, and non-transitory computer-readable recording medium for providing a correctness/incorrectness prediction for a learning question.

### BACKGROUND

The educational environment is changing rapidly due to various changes in the surrounding environment caused by the utilization of the Internet and computers. Further, the educational content market is gradually growing due to educational fervor and fierce competition for entrance examinations.

Meanwhile, with the development of artificial intelligence technology, various learning contents and application techniques that support a user's learning based on the artificial intelligence technology are being developed and released as methods of supplementing the user's insufficient knowledge, departing from the traditional methods of providing learning solutions based on the knowledge or know-how of instructors or educational institutions.

As an example of the related conventional techniques, a technique has been introduced which provides a learning material including one or more question sections, an answer sheet including solutions and correct answers to one or more questions, and a concept summary section in which concepts for the one or more questions are summarized, wherein the answer sheet includes a correct answer check part for checking whether the answer to each question is correct, a correct answer percentage calculation part for calculating a correct answer percentage for each question, and other parts related to frequencies of questions.

As another example of the related conventional techniques, a learning system has been introduced in which a user's knowledge level is inferred through a learning diagnosis based on artificial intelligence, and learning is carried out at a difficulty level according to the knowledge level.

However, according to the techniques introduced so far as well as the above-described conventional techniques, a learning concept required to solve a learning question provided to a user who carries out learning, a type of the learning question (e.g., a basic question or an advanced question), and the like are provided as a package equally to each user, without considering the learning situation or learning context of the user, so that it is difficult to recognize, for example, which learning concept the user lacks with respect to the learning question or whether the type of the learning question is appropriate for the user (e.g., whether the question should be considered as a basic question or an advanced question in view of the user's knowledge). That is, there occurs a problem that the user's learning efficiency is reduced because the user's learning is carried out without adequate consideration of the user's degree of knowledge and concept acquisition.

### SUMMARY OF THE INVENTION

One object of the present invention is to solve all the above-described problems in the prior art.

Another object of the invention is to generate concept-specific correctness/incorrectness sequence data with reference to data on a result of solving learning questions provided to a user, thereby building a concept understanding estimation model that reflects time-based weights and learning experiences of multiple users with respect to concepts, and using the model to estimate the user's understanding of each concept.

Yet another object of the invention is to provide a learning content customized for a user and increase the efficiency of learning by calculating a correctness/incorrectness prediction probability for a question in consideration of a user variable and a question-related variable as well as concept-specific correctness/incorrectness sequence data.

Still another object of the invention is to make a correctness/incorrectness prediction for a new user and a new question by grouping a user variable and a question-related variable included in a data set on the basis of context information of a user.

The representative configurations of the invention to achieve the above objects are described below.

According to one aspect of the invention, there is provided a method for providing a correctness/incorrectness prediction for a learning question, the method comprising the steps of: acquiring a set of data including a user variable determined on the basis of concept-specific correctness/incorrectness sequence data of at least one user, and at least one variable related to a question and a concept associated with the user variable; and calculating a probability that a first user corresponding to a specific user variable correctly answers a first question corresponding to a specific concept, with reference to the data set.

According to another aspect of the invention, there is provided a system for providing a correctness/incorrectness prediction for a learning question, the system comprising: a data acquisition unit configured to acquire a set of data including a user variable determined on the basis of concept-specific correctness/incorrectness sequence data of at least one user, and at least one variable related to a question and a concept associated with the user variable; and a probability calculation unit configured to calculate a probability that a first user corresponding to a specific user variable correctly answers a first question corresponding to a specific concept, with reference to the data set.

In addition, there are further provided other methods and systems to implement the invention, as well as non-transitory computer-readable recording media having stored thereon computer programs for executing the methods.

According to the invention, it is possible to generate concept-specific correctness/incorrectness sequence data with reference to data on a result of solving learning questions provided to a user, thereby building a concept understanding estimation model that reflects time-based weights and learning experiences of multiple users with respect to concepts, and using the model to estimate the user's understanding of each concept.

According to the invention, it is possible to provide a learning content customized for a user and increase the efficiency of learning by calculating a correctness/incorrectness prediction probability for a question in consideration of a user variable and a question-related variable as well as concept-specific correctness/incorrectness sequence data.

According to the invention, it is possible to make a correctness/incorrectness prediction for a new user and a new question by grouping a user variable and a question-related variable included in a data set on the basis of context information of a user.

### BRIEF DESCRIPTION OF THE DRAWINGS

FIG. 1 schematically shows the configuration of an entire system for providing a correctness/incorrectness prediction for a learning question according to one embodiment of the invention.

FIG. 2 specifically shows the internal configuration of a correctness/incorrectness prediction system according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

Herein, the term “content” or “contents” encompasses digital information or individual information elements comprised of text, symbol, speech, sound, image, video, and the like, which are accessible via communication networks. For example, such contents may comprise data such as text, image, video, audio, and links (e.g., web links) or a combination of at least two types of such data.

Herein, sequence data may refer to a series of interrelated pieces of data. For example, the sequence data may refer to time-series data, which is data recorded over time, and text data, which has a contextual order over time. Specifically, the sequence data may include first sequence data generated at a first time point and second sequence data generated at a second time point that follows the first time point by a predetermined amount of time. Further, according to one embodiment of the invention, the sequence data may contribute to predicting a probability distribution of future occurrences of data.

Herein, a concept may refer to a unit of knowledge required to understand or solve a learning question. For example, the knowledge unit or learning concept may encompass a table of contents, a curriculum unit, and the like in a curriculum.

Herein, a question may refer to a problem associated with at least one concept. The question according to one embodiment of the invention may include not only a conventional basic question provided to acquire a learning concept, but also a supplemental question that may be additionally provided together with the basic question on the basis of the user's understanding of the concept. For example, according to one embodiment of the invention, the types of the supplemental question may include a “concept-as-is” question that utilizes a single learning concept in which the user is determined to be weak, a “concept-plus” question that utilizes a learning concept different from a learning concept in which the user is determined to be weak, and the like.

Configuration of the Entire System

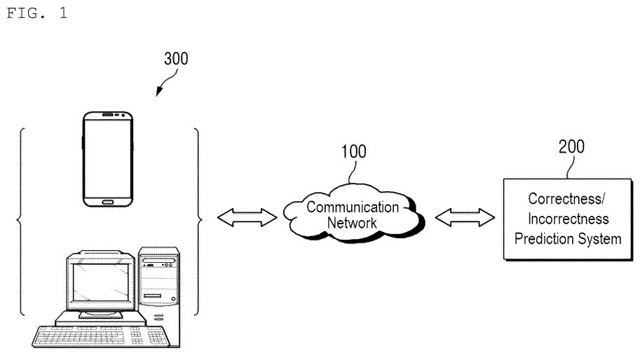

FIG. 1 schematically shows the configuration of the entire system for providing a correctness/incorrectness prediction for a learning question according to one embodiment of the invention.

As shown in FIG. 1, the entire system according to one embodiment of the invention may comprise a communication network 100, a correctness/incorrectness prediction system 200, and a user device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi Direct communication, Long Term Evolution (LTE) communication, Bluetooth communication (e.g., Bluetooth Low Energy (BLE) communication), infrared communication, and ultrasonic communication.

Next, the correctness/incorrectness prediction system 200 according to one embodiment of the invention may communicate with the user device 300 to be described below via the communication network 100, and may function to acquire a set of data including a user variable determined on the basis of concept-specific correctness/incorrectness sequence data of at least one user, and at least one variable related to a question and a concept associated with the user variable, and to calculate a probability that a first user corresponding to a specific user variable correctly answers a first question corresponding to a specific concept, with reference to the acquired data set.

The configuration and functions of the correctness/incorrectness prediction system 200 according to the invention will be discussed in more detail below. Meanwhile, the above description is illustrative although the correctness/incorrectness prediction system 200 has been described as above, and it will be apparent to those skilled in the art that at least a part of the functions or components required for the correctness/incorrectness prediction system 200 may be implemented or included in the user device 300 to be described below or an external system (not shown), as necessary.

Next, the user device 300 according to one embodiment of the invention is digital equipment that may function to connect to and then communicate with the correctness/incorrectness prediction system 200 via the communication network 100, and any type of portable digital equipment having a memory means and a microprocessor for computing capabilities, such as a smart phone and a tablet PC, may be adopted as the user device 300 according to the invention.

Meanwhile, the user device 300 according to one embodiment of the invention may include an application for supporting the functions of providing a correctness/incorrectness prediction for a learning question according to the invention. The application may be downloaded from the correctness/incorrectness prediction system 200 or an external application distribution server (not shown).

Configuration of the Correctness/Incorrectness Prediction System

Hereinafter, the internal configuration of the correctness/incorrectness prediction system 200 crucial for implementing the invention and the functions of the respective components thereof will be discussed.

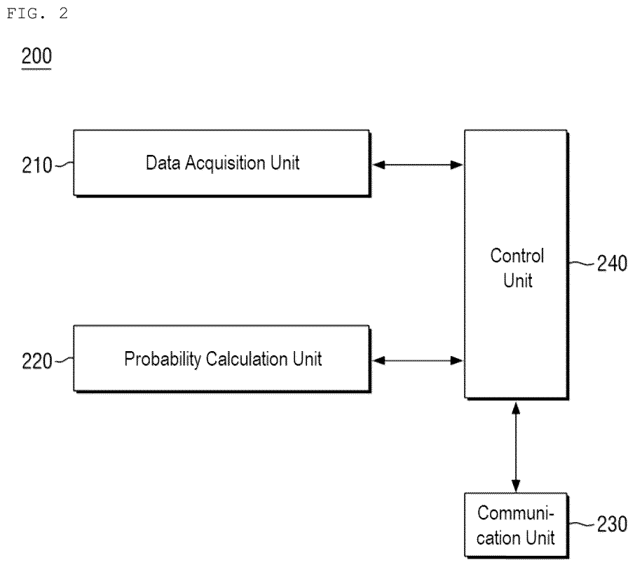

FIG. 2 specifically shows the internal configuration of the correctness/incorrectness prediction system 200 according to one embodiment of the invention.

The correctness/incorrectness prediction system 200 according to one embodiment of the invention may be digital equipment having a memory means and a microprocessor for computing capabilities. As shown in FIG. 2, the correctness/incorrectness prediction system 200 may comprise a data acquisition unit 210, a probability calculation unit 220, a communication unit 230, and a control unit 240. According to one embodiment of the invention, at least some of the data acquisition unit 210, the probability calculation unit 220, the communication unit 230, and the control unit 240 may be program modules that communicate with an external system. The program modules may be included in the correctness/incorrectness prediction system 200 in the form of operating systems, application program modules, or other program modules, while they may be physically stored in a variety of commonly known storage devices. Further, the program modules may also be stored in a remote storage device that may communicate with the correctness/incorrectness prediction system 200. Meanwhile, such program modules may include, but are not limited to, routines, subroutines, programs, objects, components, and data structures for performing specific tasks or executing specific abstract data types according to the invention as will be described below.

First, the data acquisition unit 210 according to one embodiment of the invention may acquire a set of data including a user variable determined on the basis of concept-specific correctness/incorrectness sequence data of at least one user, and at least one variable related to a question and a concept associated with the user variable.

According to one embodiment of the invention, the concept-specific correctness/incorrectness sequence data may be generated with reference to data on a result of at least one user solving at least one question associated with at least one concept.

Further, according to one embodiment of the invention, the concept-specific correctness/incorrectness sequence data may be generated by preprocessing for performing concept-specific categorization with respect to the data on the result of solving the at least one question associated with the at least one concept.

For example, according to one embodiment of the invention, the concept-specific correctness/incorrectness sequence data may be generated by preprocessing data on a result of solving questions to indicate correctness or incorrectness for each concept included in a question solved in a time-series manner by each user. According to one embodiment of the invention, the concept-specific categorization for the at least one question may be performed on the basis of concept-specific tagging made by an expert in the relevant field. Further, according to another embodiment of the invention, the concept-specific categorization for the at least one question may be performed on the basis of a natural language processing (NLP) algorithm and a clustering algorithm.

Specifically, according to one embodiment of the invention, the concept-specific categorization for the at least one question may be performed by tagging the at least one question by concept with reference to a lookup table that is pre-created by the expert to categorize concepts (e.g., which may refer to a lookup table in which concepts are pre-categorized for each question). Further, according to one embodiment of the invention, the concept-specific categorization for the at least one question may be performed with reference to the lookup table using an NLP algorithm and a clustering algorithm.

Meanwhile, the user variable according to one embodiment of the invention refers to user identification information that allows a user to be identified, and may include a user ID. For example, the user ID may be expressed as a series of identification numbers (e.g., natural numbers) that may represent a user. Specifically, according to one embodiment of the invention, the natural identification numbers may be assigned in ascending order according to the order in which the user solves given questions.

Further, the question-related variable according to one embodiment of the invention refers to question identification information that allows a question to be identified, and may include a question identification number. For example, the question identification number may be assigned to each question on the basis of the sequence of curriculum units to be learned by the user.

Furthermore, the concept-related variable according to one embodiment of the invention refers to concept identification information that allows a concept to be identified, and may include a concept identification number and a concept understanding level. For example, the concept identification number may be assigned to each concept on the basis of the sequence of concepts to be learned by the user.

Specifically, the data acquisition unit 210 according to one embodiment of the invention may acquire a data set in a matrix structure for the user variable determined on the basis of the concept-specific correctness/incorrectness sequence data, and the question-related variable and concept-related variable associated with the user variable.

More specifically, with respect to a specific question solved by a specific user, the matrix-structured data set according to one embodiment of the invention may be expressed as including data represented as 1s and 0s regarding whether the specific question includes (or is associated with) a specific concept, a concept understanding level, and data represented as 1s and 0s regarding a result of solving the specific question. In the data set according to one embodiment of the invention, a row may have a structure of [user ID, question identification number, whether a concept is included, user's understanding of each concept, and result of question solving].

For example, it may be assumed that the user ID is 213, the question identification number is 340, the number of concepts that may be applied to all questions is limited to 5, the concepts included in the question are first and fifth concepts, and the user correctly answers the question. Here, in the matrix-structured data set according to one embodiment of the invention, a row may be expressed as [213, 340, 1, 0, 0, 0, 0, 1, 0.6, 0.4, 0.3, 0.3, 0.65, 1].

Further, the user variable or the question-related variable included in the data set according to one embodiment of the invention may be grouped on the basis of at least one piece of context information.

Specifically, according to one embodiment of the invention, the user variable may be specified into a user group on the basis of demographic information of users (e.g., age, gender, major, grade level, and residence), and the data acquisition unit 210 may acquire the data set on the basis of the specified user group. For example, users with the same age, gender, major, and grade level may be categorized into a first user group. As another example, users may be categorized into a second user group in consideration of time spent solving questions, date of last access, and the like.

Further, according to one embodiment of the invention, the question-related variable may be specified into a question group on the basis of question attribute information, and the data acquisition unit 210 may acquire the data set on the basis of the specified question group. The question attribute information according to one embodiment of the invention refers to information indicating unique attributes of a question, and may include information on a recommended grade level, a recommended major, scoring, a question type (e.g., multiple choice or essay), presence or absence of an image, and the like.

Through the foregoing, it is possible to make a correctness/incorrectness prediction for a new user and a new question as the user variable and the question-related variable are grouped on the basis of context information, respectively.

Meanwhile, the structure of the data set according to the invention is not necessarily limited according to the above-described variables, and the variables and the structure of the data set may be diversely changed as long as the objects of the invention may be achieved.

Meanwhile, the concept-related variable included in the data set according to one embodiment of the invention may include the user's concept understanding, which is estimated using a concept-specific understanding estimation model trained on the basis of the concept-specific correctness/incorrectness sequence data.

A concept-specific understanding estimation model according to one embodiment of the invention may be trained on the basis of the concept-specific correctness/incorrectness sequence data.

For example, the concept-specific understanding estimation model according to one embodiment of the invention may be trained using a Bayesian knowledge tracing algorithm. Herein, the Bayesian knowledge tracing algorithm may refer to an algorithm that probabilistically models a learner's cognitive processes during the course of learning to trace the learner's level of knowledge acquisition at a given time point.

According to one embodiment of the invention, the concept-specific understanding estimation model may be trained with respect to a plurality of parameters (e.g., pre-existing knowledge, acquired knowledge, a guess, and a mistake) on the basis of the concept-specific correctness/incorrectness sequence data. According to one embodiment of the invention, the pre-existing knowledge indicates a probability that the user already possesses the knowledge, the acquired knowledge indicates a probability that the user fully understands the knowledge by solving a question, the guess indicates a probability that the user guesses a correct answer to the question without possessing the knowledge, and the mistake indicates a probability that the user possesses the knowledge but makes a mistake. Further, according to one embodiment of the invention, the plurality of parameters may be updated on the basis of an expectation maximization algorithm.

According to one embodiment of the invention, the concept-specific understanding estimation model may be trained such that the concept-specific understanding is estimated by assigning a greater weight to second sequence data generated at a second time point (e.g., following a first time point by a predetermined amount of time) than to first sequence data generated at the first time point.

For example, according to one embodiment of the invention, the second sequence data may be assigned a greater weight than the first sequence data on the basis of a weighting function.

More specifically, the weighting function according to one embodiment of the invention may be expressed as Equation 1 below.

$${w}_{tl} = \frac{{d}^{t - l}}{{\sum }_{l = 1}^{t - 1} {d}^{t - l}} ∈ ( 0 , 1 ] \qquad ( EQ . 1 )$$

Here, wₜₗ denotes a weight assigned to the l^{th} sequence data out of t pieces of sequence data, and d denotes a user-defined constant. For example, d may be set to 0.7. As another example, d may be set to a value that is observed to have the smallest error during the course of assessing the concept-specific understanding estimation model.

This allows the concept-specific understanding estimation model to more precisely estimate the user's concept understanding by assigning a greater weight to more recent sequence data, reflecting the degree of forgetting a concept over time after solving a question.

Further, the conventional Bayesian knowledge tracing algorithm is based on the assumption that a user does not forget knowledge once learned, and has a limitation that individual characteristics (e.g., difficulty) of questions cannot be considered. However, according to one embodiment of the invention, the concept-specific understanding estimation model may be trained with respect to the plurality of parameters with reference to the weighted concept-specific correctness/incorrectness sequence data, so that the user's concept understanding may be more precisely identified compared to the conventional Bayesian knowledge tracing algorithm.

Meanwhile, the concept-specific understanding estimation model according to the invention is not necessarily limited to being trained by the above algorithm, and the training algorithm may be diversely changed as long as the objects of the invention may be achieved.

According to the invention, a concept understanding estimation model may be built not only using the above concept-specific correctness/incorrectness sequence data, but also using concept-specific correctness/incorrectness sequence data of two or more users so that the model may be applied to the two or more users. Therefore, the concept understanding estimation model may reflect learning experiences of multiple learners, thereby providing concept understanding estimation results with high reliability and universality.

Further, according to one embodiment of the invention, the user's concept understanding may be estimated using a concept-specific understanding estimation model that is trained on the basis of the concept-specific correctness/incorrectness sequence data. Specifically, according to one embodiment of the invention, a user's understanding of a concept (or concept understanding) may refer to a probability that the user knows the concept at a given time point (e.g., at time point t+1) on the basis of the concept-specific correctness/incorrectness sequence data (e.g., the data through time point t).

Further, according to one embodiment of the invention, when a particular user has never solved a question about a specific concept, the user's understanding of the concept may be set to 0.5.

Meanwhile, according to one embodiment of the invention, the user's understanding of a concept that the user has not encountered may be estimated.

For example, according to one embodiment of the invention, a first user's understanding of a second concept may be estimated on the basis of a second user's understanding of the second concept.

More specifically, according to one embodiment of the invention, learning levels of the first user and the second user may be assessed by comparing concept understanding of the first user and the second user with respect to a plurality of concepts that the first user has already encountered. Next, the first user's understanding of the second concept may be estimated on the basis of the assessed learning levels of the first and second users and the second user's concept correctness/incorrectness sequence data for the second concept.

As another example, according to one embodiment of the invention, the user's understanding of a concept that the user has not encountered may be estimated by assessing the similarity between the concept that the user has not encountered and a concept that the user has already solved.

For example, a simulated annealing algorithm may be applied to a first question containing a second concept not encountered by the user and a second question containing a first concept encountered by the user, thereby assessing the similarity between the first and second concepts. According to one embodiment of the invention, on the basis of the assessed similarity between the concepts, the user's understanding of the concept not encountered by the user may be estimated from the user's understanding of the concept encountered by the user.

Meanwhile, according to one embodiment of the invention, the user's understanding of a concept not encountered by the user may be estimated on the basis of a collaborative filtering algorithm.

For example, the user's understanding of the concept not encountered by the user may be estimated using a matrix factorization algorithm on the concept-specific correctness/incorrectness sequence data represented in a matrix structure with respect to a plurality of concepts (e.g., which may be a first concept encountered by the user and a second concept not encountered by the user) and results of a plurality of users solving questions. As another example, since the times at which the concept understanding is estimated for the plurality of users are different, the user's understanding of the concept not encountered by the user may be estimated using a temporal dynamics algorithm.

Further, according to one embodiment of the invention, the concept-specific understanding estimation model may be assessed using a result of estimating the user's concept understanding.

For example, according to one embodiment of the invention, the concept-specific understanding estimation model may be assessed on the basis of a k-fold cross validation algorithm. Specifically, the k-fold cross validation algorithm according to one embodiment of the invention refers to an algorithm for assessing the model by successively alternating training and validation steps, such that all the concept correctness/incorrectness sequence data is assessed. Meanwhile, the concept-specific understanding estimation model according to the invention is not necessarily limited to being assessed by the above algorithm, and the assessment algorithm for optimizing the model may be diversely changed as long as the objects of the invention may be achieved.

Next, the probability calculation unit 220 according to one embodiment of the invention may calculate a probability that a user corresponding to a specific user variable correctly answers a question corresponding to a specific concept, with reference to the acquired data set.

For example, the probability according to one embodiment of the invention may refer to a conditional probability calculated using a binary classification algorithm. Specifically, the probability calculation unit 220 according to one embodiment of the invention may train a binary classification model on the basis of the user variable, the question-related variable, and the concept-related variable (e.g., the user's concept understanding estimated using the concept-specific understanding estimation model trained on the basis of the concept-specific correctness/incorrectness sequence data) included in the data set, and use the trained model to calculate a probability that the user correctly answers a specific question. For example, the binary classification model may be a logistic regression model, a multi-layer perceptron (MLP), or a support vector machine (SVM).

More specifically, the probability calculation unit 220 according to one embodiment of the invention may train a binary classification model through the data set in which the user variable and the question-related variable are grouped on the basis of context information (e.g., demographic information and question attribute information) to calculate a probability that a new user correctly answers a new question using the trained model, without having to separately designate or specify a variable for the new user or the new question.

Meanwhile, the binary classification model according to the invention is not necessarily limited to the above model, and may be diversely changed as long as the objects of the invention may be achieved.

Furthermore, the probability calculation unit 220 according to one embodiment of the invention may make a correctness/incorrectness prediction for a learning question on the basis of the probability calculated using the binary classification algorithm.

Specifically, the probability calculation unit 220 according to one embodiment of the invention may predict that a user will correctly answer a specific question if the probability calculated using the binary classification algorithm exceeds a predetermined threshold, and predict that the user will incorrectly answer the specific question if the probability does not exceed the predetermined threshold.

Next, the communication unit 230 according to one embodiment of the invention may function to enable data transmission/reception from/to the data acquisition unit 210 and the probability calculation unit 220.

Lastly, the control unit 240 according to one embodiment of the invention may function to control data flow among the data acquisition unit 210, the probability calculation unit 220, and the communication unit 230. That is, the control unit 240 according to the invention may control data flow into/out of the correctness/incorrectness prediction system 200 or data flow among the respective components of the correctness/incorrectness prediction system 200, such that the data acquisition unit 210, the probability calculation unit 220, and the communication unit 230 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A method for providing a correctness or incorrectness prediction for a learning question, the method comprising the steps of:
acquiring a set of data including a user variable determined on the basis of concept-specific correctness or incorrectness sequence data of at least one user, and at least one variable related to a question and a concept associated with the user variable; and
calculating a probability that a first user corresponding to a specific user variable correctly answers a first question corresponding to a specific concept, with reference to the data set.

2. The method of claim 1, wherein in the calculating step, the probability is calculated using a binary classification algorithm.

3. The method of claim 1, wherein the user variable or the question-related variable included in the data set is grouped on the basis of at least one piece of context information.

4. The method of claim 1, wherein the concept-related variable included in the data set includes a user's concept understanding estimated using a concept-specific understanding estimation model trained on the basis of the concept-specific correctness or incorrectness sequence data.

5. A non-transitory computer-readable recording medium having stored thereon a computer program for executing the method of claim 1.

6. A system for providing a correctness or incorrectness prediction for a learning question, the system comprising:
a data acquisition unit configured to acquire a set of data including a user variable determined on the basis of concept-specific correctness or incorrectness sequence data of at least one user, and at least one variable related to a question and a concept associated with the user variable; and
a probability calculation unit configured to calculate a probability that a first user corresponding to a specific user variable correctly answers a first question corresponding to a specific concept, with reference to the data set.

7. The system of claim 6, wherein the probability calculation unit is configured to calculate the probability using a binary classification algorithm.

8. The system of claim 6, wherein the user variable or the question-related variable included in the data set is grouped on the basis of at least one piece of context information.

9. The system of claim 6, wherein the concept-related variable included in the data set includes a user's concept understanding estimated using a concept-specific understanding estimation model trained on the basis of the concept-specific correctness or incorrectness sequence data.
